(19) United States
(12) Patent Application Publication
(10) Pub. No.: US 2019/0048750 A1
(43) Pub. Date: Feb. 14, 2019

(54) DUAL MODE WASTE HEAT RECOVERY EXPANDER AND CONTROL METHOD

(71) Applicant: BORGWARNER INC., Auburn Hills, MI (US)

(72) Inventors: Frederick M. HUSCHER, Hendersonville, NC (US); Christopher J. MAYS, Bloomfield, MI (US)

(73) Assignee: BorgWarner Inc., Auburn Hills, MI (US)

(21) Appl. No.: 16/075,852

(22) PCT Filed: Feb. 8, 2017
(86) PCT No.: PCT/US2017/016883

§ 371 Date: Aug. 6, 2018

Related U.S. Application Data
(60) Provisional application No. 62/295,323, filed on Feb. 15, 2016.

(51) Int. Cl. F01K 23/08; F01K 23/14; H02K 7/108; H02K 7/18

(52) U.S. Cl. CPC F01K 23/08; H02K 7/1815; H02K 7/108; F01K 23/14

(57) ABSTRACT

A number of variations may include a system which may include a waste heat recovery system which may have at least a first boiler operably coupled to a vehicle engine system to recover waste heat therefrom. The waste heat recovery system may additionally include a working fluid. The working fluid may provide energy directly to a crank shaft of the vehicle engine system or to an electrical generator or both which may be constructed and arranged to convert the energy from the working fluid into electrical energy and/or mechanical energy and at a controlled ratio as desired.

### CROSS-REFERENCE TO RELATED APPLICATIONS

This application claims the benefit of U.S. Provisional Application No. 62/295,323 filed Feb. 15, 2016.

### TECHNICAL FIELD

The field to which the disclosure generally relates to includes waste heat recovery systems and dual mode waste heat recovery expanders and methods of making and using the same.

### BACKGROUND

Vehicles may be operated in a way which produces waste heat and further may be operated to convert the waste heat into useful energy or convert the waste heat into a useful form.

### SUMMARY OF ILLUSTRATIVE VARIATIONS

A number of variations may include a system which may include a waste heat recovery system which may have at least a first boiler or evaporator operably connected to a vehicle engine system in order to recover waste heat therefrom. Additionally, the waste heat recovery system may include a working fluid. Moreover, in conjunction with an expansion device the working fluid may provide energy directly or indirectly to a crank shaft of the vehicle engine system, to the transmission, or driveline of the vehicle. The working fluid may provide energy directly to an electrical generator, a hydraulic storage device (e.g., accumulator) or a mechanical storage device (e.g., flywheel). It is contemplated that the electrical generator may be constructed and arranged to convert the energy from the working fluid into electrical energy.

A number of other variations may include a method which may include first providing a waste heat recovery system. A waste heat recovery system may have a working fluid and may also include at least a first boiler or evaporator which may be operably coupled to a vehicle engine system. Next, waste heat may be recovered from the vehicle engine system. Finally, the energy from the working fluid may be transferred directly or indirectly to a crank shaft of the vehicle engine system or may be transferred to an electrical generator via an expansion device, a hydraulic storage device (e.g., accumulator) or a mechanical storage device (e.g., flywheel). The electrical generator or other accumulation device may be constructed and arranged to convert the expansion device work into electrical energy or other storable form.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a schematic illustration of a system according to a number of variations.

### DETAILED DESCRIPTION OF ILLUSTRATIVE VARIATIONS

The following description of the variations is merely illustrative in nature and is in no way intended to limit the scope of the invention, its application, or uses.

A number of variations may include a system which may include a waste heat recovery system 14 which may have at least a first boiler 50. The first boiler 50 may be operably connected to a vehicle engine system 40 in order to recover waste heat therefrom. Moreover, the waste heat recovery system 14 may also include a working fluid. It is contemplated that the working fluid may provide energy directly to a crank shaft 41 of the vehicle engine system 40 or to an electrical generator 43 via an expansion device 26. The electrical generator 43 may be constructed and arranged to convert the waste heat energy from the engine or other vehicle systems harvested by the working fluid into electrical energy or other storable energy forms.

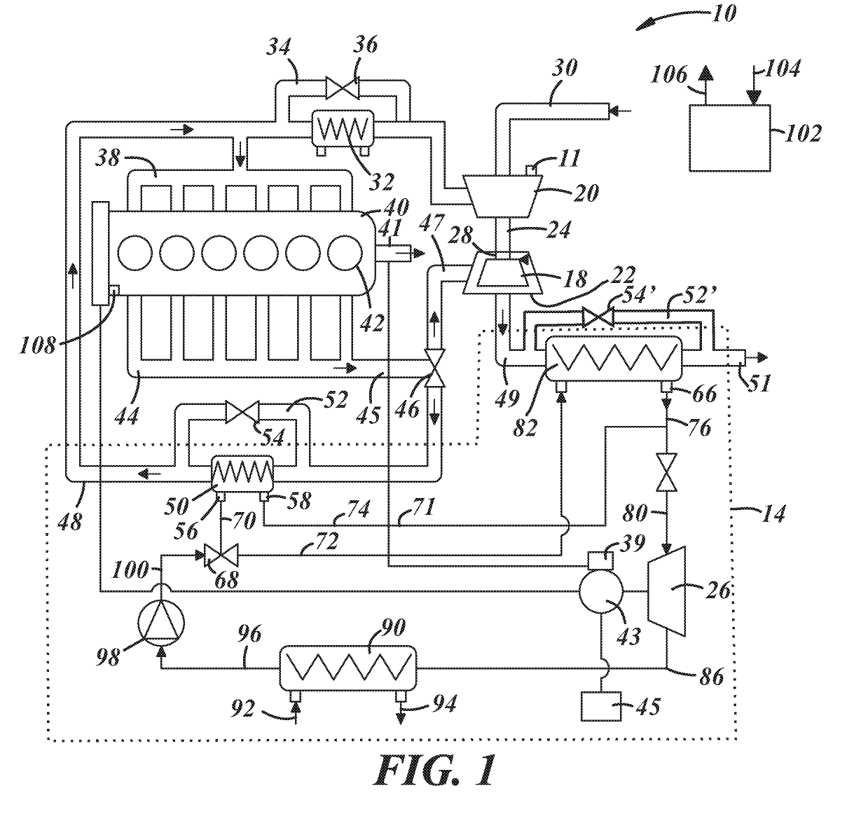

As illustrated in the variations shown in FIG. 1, a system 10 may include the waste heat recovery system 14. The waste heat recovery system 14 may be an organic Rankine cycle or may be any other waste heat recovery system as known by one of ordinary skill in the art. It is contemplated that the waste heat recovery system 14 may include a waste heat recovery system expander 26. The waste heat recovery system expander 26 may also include a turbine, a piston, a scroll machine, or other feature as known by one of ordinary skill in the art which may be coaxially connected to the generator 43. Additionally or alternatively, an electrically operated friction clutch 39 may be coaxially connected to the generator 43. Additionally, it is contemplated that the electrically operated friction clutch 39 may axially overhang the generator 43. It is additionally contemplated that the electronically operated friction clutch 39 may have a gear or other mechanical connection attached thereto. The mechanical connection may provide a reduction. Additionally, it is contemplated that a controller 102 may control the power output of the generator 43. The controller 102 may be a computer, computer program, or any other controller as known by one of ordinary skill in the art. Moreover, the controller may alter the proportion of power that may be transferred to either the electrical system or mechanical coupling based on the most efficient operation of the vehicle engine.

It is contemplated that a number of variations as illustrated in FIG. 1 may enable fuel saving benefits. First, by directly coupling the waste heat recovery system expander 26 and the crank shaft 41, electrical losses may be eliminated as this method does not use or have a need for an electrical generator. In various prior art methods, there may be efficiency losses when the vehicle engine runs outside of the expansion device's design regime. These efficiency losses may be due to the operating envelope of the waste heat recovery system expander as the speed of the waste heat recovery system expander may be directly proportional to the rotational speed of the engine crank shaft. According to a number of variations as illustrated in FIG. 1, the waste heat recovery system 14 and vehicle engine system 40 of the present invention along with the controller may allow the waste heat recovery system 14 to use the advantages of either or both direct mechanical coupling or electrical system use in order to extract maximum thermal and mechanical efficiency from the waste heat of the working fluid.

Additionally as shown in a number of variations illustrated in FIG. 1, the waste heat recovery system expander 26 may be used in additional ways to further lessen fuel use. It is contemplated that the system 10 may have the ability to couple the generator 43 directly to the crank shaft 41. Additionally or alternatively the system may be used to convert excess kinetic energy from the engine 40 into electrical energy during vehicle deceleration events instead of converting the energy to heat through conventional braking methods. Additionally or alternatively, the generator 43 may be used as a traction motor in order to assist the vehicle drive train during high load events. This may enable fuel savings through engine downsizing and down speeding. Moreover, since the electric generator must be sufficiently large for waste heat recovery, the generator 43 may also replace an engine starter motor and alternator. This may enable engine start, stop, and idle elimination for additional fuel savings. Moreover, this may reduce overall engine cost and weight by replacing components and shrinking the overall engine packing volume.

According to a number of variations as described above and additionally and/or alternatively shown in FIG. 1, the system may include the waste heat recovery system 14. The waste heat recovery system 14 may be an organic Rankine cycle or may be any other waste heat recovery system as known by one of ordinary skill in the art. The system 10 may further include an engine 40 or engine system which may include an air intake line 30 which may be operatively connected to the compressor 20. The air intake line 30 may also include an air charger cooler 32 and an air charge cooler bypass line 34. The air charge cooler bypass line 34 may have a valve 36 therein and may additionally or alternatively be provided to be constructed and arranged so that at least a portion of air flowing through the air intake line 30 may bypass the air charge cooler 32 when desired by a user. An air intake manifold 38 may be operatively connected to the air intake line 30 and may further be constructed and arranged to provide air flow to a plurality of combustion chambers 42 of the engine 40. Additionally, an exhaust manifold 44 may be operatively connected to the engine 40 in order to receive exhaust which may be expelled from the plurality of combustion chambers 42. An exhaust conduit 45 may be provided between the exhaust manifold 44 and an exhaust gas recirculation valve (EGR) 46. A high pressure exhaust gas recirculation loop line 48 may be connected to the exhaust gas recirculation valve 46.

The waste heat recovery system 14 may additionally include the first boiler 50 which may be provided in the high pressure exhaust gas recirculation loop line 48. The first boiler 50 may include an inlet 56 which may provide an inlet for working fluid of the waste heat recovery system 14 to enter the first boiler 50. Additionally, the first boiler 50 may include an outlet 58 in order for the working fluid to exit the first boiler 50. It is contemplated that the waste heat recovery system 14 may include a first boiler bypass line 52. A valve 54 may be included therein which may be constructed and arranged to allow at least a portion of the exhaust gas flowing through the high pressure exhaust gas recirculation loop line 48 to bypass the first boiler 50 when desired by a user or by the controller 102. Additionally, the high pressure exhaust gas recirculation loop line 48 may be connected from the first boiler 50 and bypass line 52 to the air intake manifold 38 in an indirect or direct fashion.

Referring again to the variations illustrated in FIG. 1, an exhaust conduit 47 may extend from the exhaust gas recirculation valve 46 to a turbine 22 of the turbocharger 18. Exhaust from the turbine 22 may exit through the exhaust line 49 and may continue to an optional second boiler 82 or out to atmosphere. Again the second boiler 82 may include an inlet for allowing the working fluid from the waste heat recovery system to enter the second boiler 82. Additionally, the second boiler 82 may include an outlet 66 for allowing the working fluid to exit the expander 82. The outlet 66 of the second boiler 82 may be operably coupled to a conduit 71. A low pressure exhaust gas recirculation loop may additionally be connected to the exhaust segment 51 and to the air intake line 30 if desired by a user.

As additionally illustrated in FIG. 1, the working fluid line 76 may be connected to the waste heat recovery expander 26. Additionally, the working fluid line 86 may be additionally connected to the condenser 90. It is contemplated that the condenser 90 may include a cooling fluid inlet line 92 and additionally a cooling fluid outlet line 94 or could be exposed to the ambient environment to provide heat transfer away from the working fluid. A working fluid line 96 may be connected from the condenser 90 to a pump 98. The pump 98 may be constructed and arranged to increase the pressure of the working fluid. A working fluid line 100 may be connected to the pump 98 and additionally to the three-way valve 68. The three-way valve 68 may control the flow of working fluid through the working fluid line and entering into the first boiler 50. The working fluid line 72 may extend from the three-way valve 68 to the inlet 64 of the second boiler 82.

A controller 102 may be provided and may be constructed and arranged to receive input signals 104 from a plurality of sensors including but not limited to, an engine sensor 108, a sensor on the compressor 11, a sensor in one or more of the working fluid lines, or any other portion of the system 10 or waste heat recovery system 14 as desired by one of ordinary skill in the art. It is contemplated that the controller may send at least one output signal 106 which may control one or more components of the system 10.

It is contemplated that the waste heat recovery expander 26 may be constructed and arranged to produce shaft work and may be connected to a shaft of an electrical generator. Electricity produced by the generator may be delivered to a converter if necessary and then stored in a battery or other storage device if desired by a user. A battery charge controller may be provided and may control the timing rate and parameters of charging of the battery. An electrical outlet line may be connected to the battery and at least one of the waste heat recovery pump 98, a condenser coolant pump, or other component in the vehicle in order to selectively supply power thereto.

In a number of variations as illustrated in FIG. 1, the controller 102 or other devices may be used to determine a rapid increase in the load demand on the engine which include but are not limited to when the vehicle operator rapidly depresses the accelerator to speed up the vehicle to pass a vehicle, rapid lane change, or similar situations

In a number of variations suitable working fluids of the waste heat recovery system 14 may include but are not limited to at least one of ethanol, water, toluene, methanol, refrigerants, or other fluids as known by one of ordinary skill in the art.

In a number of variations the controller 102 may be an electronic control module which may be connected to a plurality of vehicle components including but not limited to the engine 40, the generator 43, the mechanical energy recovery component and/or the expander 26. The controller 102 may include hardware and/or software constructed and arranged to control the components including the components of the waste heat recovery cycle 14 and the vehicle engine system 40. It is contemplated that at least a second electronic control module (or more electronic control modules) may be provided to control the operation of one or more components (or systems of components) in the vehicle. The second electronic control module may include hardware and software constructed and arranged to carry out a variety of operating processes associated with the components and/or systems.

The electronic control module and the second electronic control module may each receive process input from various sensors and transmit various output signals to various actuators. It is contemplated that the electronic control module and the second electronic control module may be operated independently of one another or the secondary electric control module may be operated in conjunction with the electronic control module in at least some operations and process control situations. It is contemplated that the electronic control module and the second electronic control module may each include at least one electrical circuit, electrical circuit or control processing chip, and/or a computer system. In an illustrative computer variation, the electronic control module and the secondary electronic control module each may generally include one or more processors, memory devices or one or more interfaces which may couple the processors to one or more other devices. It is contemplated that the processors and other powered system devices may be supplied with the electricity by a power supply. The power supply may be one or more of batteries, fuel cells, or other power supplies as known by one of ordinary skill in the art. The processors may execute instructions which may provide at least some of the functionality for the disclosed system and methods.

As used herein the term instructions may include but are not limited to control logic, computer software and/or firmware, programmable instructions, or other suitable instructions. The processor may include, for example, one or more microprocessors, microcontrollers, application specific integrated circuits, programmable logic devices, field programmable gate arrays, and/or any other suitable type of electronic processing devices. The memory device may also be configured to provide storage for data received by or loaded to the engine system, and/or for processor executable instructions. The data and/or instructions may be stored for example as look up tables, formulas, algorithms, maps, models and/or any other suitable format as known by one of ordinary skill in the art.

The memory may include RAM, ROM, EP ROM and/or any other suitable type of storage article and/or device. Additionally the interfaces may include analog, digital or digital analog converters, signal conditioners, amplifiers, filters, other electronic devices or software modules and/or any other suitable interfaces. The interfaces may make and form to for example RS232, parallel, small computer system interface, universal serial bus, CAN, MOST, LIN, flex ray, and/or any other suitable protocols. Moreover, the interfaces may include circuits, software firmware and/or any other device in order to assist or enable the electronic control module and/or the second electronic control module in communicating with other devices.

The methods or parts thereof may be implemented in a computer program product including instructions carried out on a computer readable medium for use by one or more processors in order to implement one or more of the method steps. The computer program product may also include one or more software programs comprised of program instructions and source code, object code, executable code, or other formats; one or more firmware programs; or hardware description language files; and any program related data. The data may include data structures, lookup tables, or data in any other suitable format. The program instructions may include program modules, routines, programs, objects, components, etc. The computer program may be executed on processor or in multiple processors in communication with one another.

The programs can be embodied on a computer readable media, which can include one or more storage devices, articles of manufacturer, etc. Illustrative computer readable media include computer system memory, RAM, ROM, semi-conductor memory, electronically erasable programmable read-only memory, flash memory, magnetic or optical discs or tapes, etc. The computer readable medium may also include computer to computer connections, for examples, when data is transferred or provided over a network or other communications network whether wired, wireless or a combination thereof. Any combination of the above examples is also included within the scope of computer readable media. It is therefore to be understood that the method may be at least partially performed by any electronic articles and/or devices capable of executing instructions corresponding to one or more steps of the disclosed methods.

Empirical modules may be developed from controlling the operation of one or more various components including but not limited to the waste heat recovery system, the turbocharger, the expander along with the exhaust gas recirculation loops and components thereof and the engines can include look up tables, maps and the like that may cross reference cylinder pressure with oxygen concentration or other combustion control methods. As used herein the term module may include any construct that represents something using variables such as a look up table, map, formula, algorithm, etc., modules may be application specific in particular to the exact design and performance specifications of any given engine system. In one example, the engine system modules may in turn be responsive to engine speed and intake manifold pressure and temperature.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a system which may include a waste heat recovery system. The waste heat recovery system may have at least a first boiler operably connected to a vehicle engine system to recover waste heat therefrom and may additionally include a working fluid, wherein the working fluid may provide energy directly to a crank shaft of the vehicle engine system or to an electrical generator which may be constructed and arranged to convert the energy from the working fluid into electrical energy.

Variation 2 may include the system as set forth in variation 1 wherein the waste heat recovery system further includes a waste heat recovery expander.

Variation 3 may include the system as set forth in variation 2 wherein the waste heat recovery system may also include a generator.

Variation 4 may include the system as set forth in any of variations 1 to 3 wherein the waste heat recovery system further includes a turbine, piston or scroll machine.

Variation 5 may include the system as set forth in any of variations 1 to 4 wherein the waste heat recovery system may further include a friction clutch.

Variation 6 may include the system as set forth in any of variations 1 to 5 wherein the electric generator may enable engine start-up and shut down.

Variation 7 may include the system as set forth in any of variations 1 to 6 wherein the vehicle engine system may not include an engine starter motor or an alternator.

Variation 8 may include the system as set forth in any of variations 1 to 7 wherein the waste heat recovery system is an organic Rankine cycle.

Variation 9 may include a method which may include providing a waste heat recovery system which may have a working fluid and at least one boiler operably coupled to a vehicle engine system. Next, the waste heat may be recovered from the vehicle engine system. Next, the energy may be transferred from the working fluid directly to a crank shaft of the vehicle engine system or to an electrical generator which may be constructed and arranged to convert the waste heat energy from the working fluid into electrical energy.

Variation 10 may include the method as set forth in variation 9 wherein the waste heat recovery system may also include a waste heat recovery expander.

Variation 11 may include the method as set forth in any of variations 9 to 10 wherein the waste heat recovery system may include a generator.

Variation 12 may include the method as set forth in any of variations 9 to 11 wherein the waste heat recovery system may further include a turbine, piston or scroll machine.

Variation 13 may include the method as set forth in any of variations 9 to 12 wherein further comprising enabling engine start-up and shut down without an electric generator.

Variation 14 may include the method as set forth in any of variations 9 to 13 wherein the vehicle engine system does not include an engine starter motor or an alternator.

Variation 15 may include the method as set forth in any of variations 9 to 14 wherein the waste heat recovery system is an organic Rankine cycle.

The above description of select variations within the scope of the invention is merely illustrative in nature and, thus, variations or variants thereof are not to be regarded as a departure from the spirit and scope of the invention.

1. A system comprising:
a waste heat recovery system having at least a first boiler operably coupled to a vehicle engine system in order to recover waste heat therefrom using a working fluid; and
wherein the working fluid is constructed and arranged to provide energy to a crank shaft of the vehicle engine system, wherein the waste heat recovery system comprises an electrical machine constructed and arranged to covert energy from the working fluid into electrical energy, wherein the waste heat recovery system comprises a waste heat recovery expander mechanically connected to the electric machine and selectively connected to the crank shaft, wherein at least one of the electric machine or expander provides the energy to the crank shaft.

2. The system of claim 1, wherein both of the electric machine and the expander provide the energy to the crank shaft.

3. The system of claim 1, wherein the electric machine is selectively connected to the crank shaft.

4. The system of claim 1, wherein the waste heat recovery system further includes a turbine, piston or scroll machine.

5. The system of claim 1, wherein the waste heat recovery system may further include a friction clutch.

6. The system of claim 1, wherein the electric generator is constructed and arranged to enable the vehicle engine system to start-up and shut down.

7. The system of claim 1, wherein the vehicle engine system does not include an engine starter motor or an alternator.

8. The system of claim 1, wherein the waste heat recovery system uses an organic Rankine cycle.

9. A method comprising:
providing a waste heat recovery system which having a working fluid and at least one boiler operably coupled to a vehicle engine system;
recovering waste heat energy from the vehicle engine system using a working fluid; and
transferring the waste heat energy from the working fluid to a crank shaft of the vehicle engine system, wherein the waste heat recovery system comprises an electrical generator constructed and arranged to convert the waste heat energy from the working fluid into electrical energy, wherein the waste heat recovery system comprises a waste heat recovery expander mechanically connected to the electric machine and selectively connected to the crank shaft, wherein at least one of the electric machine or expander provides the energy to the crank shaft.

10. The method of claim 9, wherein both of the electric machine and the expander provide the energy to the crank shaft.

11. The method of claim 9, wherein the electric machine is selectively connected to the crank shaft.

12. The method of claim 9, wherein the waste heat recovery system further includes a turbine, piston or scroll machine.

13. The method of claim 9, further comprising enabling the vehicle engine system to start-up and shut down without an electric generator.

14. The method of claim 9, wherein the vehicle engine system does not include an engine starter motor or an alternator.

15. The method of claim 9, wherein the waste heat recovery system is an organic Rankine cycle.

16. The product as set forth in claim 3 wherein the amount of energy provide by the electrical machine by the mechanically connection to the crank shaft and the amount of energy converted by the electrical machine to electrical energy is at a controlled ratio.

17. The product as set forth in claim 1 wherein only the expander provides energy to the crank shaft.

18. The product as set forth in claim 1 wherein only the electric machine provides energy to the crank shaft.

19. The product as set forth in claim 1 wherein the electric machine comprises a traction motor.

20. The product as set forth in claim 1 wherein the electric machine is constructed and arrange to perform as a starter motor.

21. The product as set forth in claim 1 wherein the system comprises an engine and an engine inlet line connected to the engine, an engine exhaust line connected to the engine, and an exhaust gas recirculation line connected to the engine exhaust line and the engine inlet line, and wherein the waste heat recovery system comprises a boiler in the exhaust gas recirculation line.

22. The product as set forth in claim 1 wherein the system comprises turbocharger having a turbine connected to an engine exhaust line, a turbine outlet exhaust line connected to the turbine and open to the atmosphere, wherein the waste heat recovery system comprises a boiler in the turbine outlet exhaust line.

23. The product as set forth in claim 1 wherein the system comprises an engine and an engine inlet line connected to the engine, an engine exhaust line connected to the engine, and an exhaust gas recirculation line connected to the engine exhaust line and the engine inlet line, and a first boiler in the exhaust gas recirculation line, wherein the system comprises turbocharger having a turbine connected to the engine exhaust line, a turbine outlet exhaust line connected to the turbine and open to the atmosphere, waste heat recovery system comprises a second boiler in the turbine outlet exhaust line.

24. The product as set forth in claim 3 wherein the amount of energy provide by the electrical machine by the mechanically connection to the crank shaft and the amount of energy converted by the electrical machine to electrical energy is at a controlled ratio.

25. The method as set forth in claim 9 wherein only the expander provides energy to the crank shaft.

26. The method as set forth in claim 9 wherein only the electric machine provides energy to the crank shaft.

27. The method as set forth in claim 9 wherein the electric machine comprises a traction motor.

28. The method as set forth in claim 9 wherein the electric machine is constructed and arrange to perform as a starter motor.

29. The method as set forth in claim 9 wherein the system comprises an engine and an engine inlet line connected to the engine, an engine exhaust line connected to the engine, and an exhaust gas recirculation line connected to the engine exhaust line and the engine inlet line, and wherein the waste heat recovery system comprises a boiler in the exhaust gas recirculation line.

30. The method as set forth in claim 9 wherein the system comprises turbocharger having a turbine connected to an engine exhaust line, a turbine outlet exhaust line connected to the turbine and open to the atmosphere, wherein the waste heat recovery system comprises a boiler in the turbine outlet exhaust line.

31. The method as set forth in claim 9 wherein the system comprises an engine and an engine inlet line connected to the engine, an engine exhaust line connected to the engine, and an exhaust gas recirculation line connected to the engine exhaust line and the engine inlet line, and a first boiler in the exhaust gas recirculation line, wherein the system comprises turbocharger having a turbine connected to the engine exhaust line, a turbine outlet exhaust line connected to the turbine and open to the atmosphere, waste heat recovery system comprises a second boiler in the turbine outlet exhaust line.
